(19) United States
(12) Patent Application Publication
(10) Pub. No.: US 2008/0031136 A1
(43) Pub. Date: Feb. 7, 2008

(54) ROUND TRIP TIME (RTT) PROXIMITY DETECTION TESTING

(76) Inventors: Sherman L. Gavette, Camas, WA (US); Shugong Xu, Vancouver, WA (US)

Correspondence Address: MICHAEL BLAINE BROOKS, PC, P.O. BOX 1630, SIMI VALLEY, CA, 93062-1630, US

(21) Appl. No.: 11/462,930

(22) Filed: Aug. 7, 2006

(51) Int. Cl. H04L 12/26

(52) U.S. Cl. 370/235

(57) ABSTRACT

The embodiments of the present invention provide for methods, devices, and systems for proximity detection with forced delays within networks providing quality of service. In some embodiments, the size of one or more contention-based access regions is modified.

### FIELD OF THE INVENTION

The embodiments of the present invention relate to proximity detection, particularly to round trip time proximity detections in local area networks that provide quality of service.

### BACKGROUND

Protection of digital data from unauthorized copying and distribution is a concern for intellectual property owners and controllers. This concern is of increasing importance, as consumers now desire to move digital content between digital devices. Consumers, for example, may desire to move video contents between their personal computers (PCs), digital video or versatile disc (DVD) players, set-top boxes, and digital televisions (DTVs). One standard or framework currently being developed and currently available is digital transmission content protection (DTCP).

DTCP over Internet Protocol (DTCP-IP) enables digital content to be carried over IP within a home network. One of the requirements for supporting DTCP over IP is to prevent content from leaving a local area network, such as the home. DTCP imposes proximity detections that constrain the round-trip time (RTT) for a pair of Internet Protocol (IP) packets to be sufficiently short, e.g., 7 ms, to ensure that the path between the endpoints are localize and possibly not involving a wide area network, e.g., the Internet. The typical results of failing the RTT test may include a consumer experiencing a significant time delay after they choose to play a protected/premium content; or even worse, after 1024 RTT test failures, the authentication and key exchange (AKE) process entirely fails thereby resulting in the consumer being unable to play the content even if the consumer owns or is authorized to play the content.

Quality of service (QOS) is an import factor for multimedia applications. A method of facilitating RTT proximity detections on LANs that provide quality of service is desirable.

### SUMMARY

In one aspect of the invention, a method of proximity detection within a network is provided. The method includes the step of determining a network load. Furthermore, if the determined network load meets a defined condition, then performing a round trip time (RTT) proximity detection test. Otherwise, if the determined network load fails the defined condition, then performing a forced delay RTT proximity detection test with a forced delay.

In another aspect, another method of proximity detection is provided. The method includes the steps of: receiving, by a first device, a message from a second device indicating that the second device is ready to perform a forced delay round trip time (RTT) proximity detection test; and transmitting after a forced delay, by the first device, a response message in response to the received message, the response message adapted to trigger initiation of the forced delay RTT test.

In another aspect, another method of proximity detection is provided. The method includes the steps of: identifying ready messages, each of the ready messages indicating that a device is ready for a round trip time (RTT) proximity detection test; releasing to an application, after a forced delay, at least one ready message of the ready messages; transmitting a start message adapted to trigger initiation of the RTT proximity test, in response to the at least one ready message; and receiving the start message at an interface operably connected to a source device, wherein the forced delay is based on having the step of receiving the start message occur proximate to a contention-based access period.

In another aspect, a device adapted to be operably coupled with another device via at least one network segment is provided. This device includes a network load measurement module and a round trip time test module. The network load measurement module is adapted to: send a request message requesting an echo reply message; receive the echo reply message; and determine the time difference between the sending of the request message and the reception of the echo reply message to determine a network load. The RTT test module, on the other hand, is adapted to: perform a RTT proximity detection test; and perform a forced delay RTT proximity detection test when the determined network load does not satisfy a defined condition.

In another aspect, a system is provided that includes a first device, a second device, and at least one network segment. The first device is operably coupled to the second device via at least one network segment. The first device is adapted to: send a SETUP message indicating to the second device to prepare for initiation of a forced delay RTT proximity detection test; receive a READY message in response to the SETUP message indicating that the second device is ready for the forced delay RTT proximity detection test; after a forced delay, send the START message adapted to trigger initiation of the forced delay RTT proximity detection test; receive the STOP message adapted to trigger completion of the forced delay RTT proximity detection test; and determine a round trip time based on the sending of the START message after a forced delay and the receiving of the STOP message. The second device, on the other hand, is adapted to: receive the SETUP message; send a READY message in response to the received SETUP message when the second device is ready for the forced delay RTT proximity detection test; receive the START message; and send the STOP message.

### BRIEF DESCRIPTION OF THE DRAWINGS

The present invention is illustrated by way of example and not limitation in the figures of the accompanying drawings, and in which:

FIG. 1A is a high-level block diagram of an exemplary data communication system according to an embodiment of the invention;

FIG. 1B is a high-level block diagram of an exemplary power line communication network according to an embodiment of the invention;

FIG. 2 is a high-level block diagram of a source/transmitting device and a sink/receiving device, according to an embodiment of the invention;

FIG. 3 is a high-level flowchart showing when a round trip time (RTT) test with a forced delay may be performed according to an embodiment of the invention;

FIG. 4 is an exemplary diagram illustrating the exemplary exchange of ping-like commands to measure the network load, according to an embodiment of the invention;

FIG. 5 is a high-level functional data flow diagram of an exemplary digital transmission content protection (DTCP) environment, according to an embodiment of the invention;

FIG. 6 is a high-level diagram showing the exchange of RTT-related messages in an RTT without a forced delay test, according to an embodiment of the invention;

FIG. 7 is a high-level diagram showing delays that may be incurred while a message is sent from one application to another, according to an embodiment of the invention;

FIG. 8 is a high-level diagram showing two exemplary beacon periods, wherein quality of service is provided by allocating contention-free periods, according to an embodiment of the invention;

FIG. 9 is a high-level diagram showing RTT-related messages being exchanged with a forced delay, according to an embodiment of the invention;

FIG. 10 is a high-level diagram showing an exemplary embodiment indicating where a forced delay may be performed, according to an embodiment of the invention;

FIG. 11 is a high-level block diagram illustrating the placement of CSMA regions to facilitate complying with the RTT constraint, according to an embodiment of the invention; and

FIG. 12 is a high-level functional block diagram of an exemplary device that is adapted to be used within the system, according to an embodiment of the invention.

### DETAILED DESCRIPTION

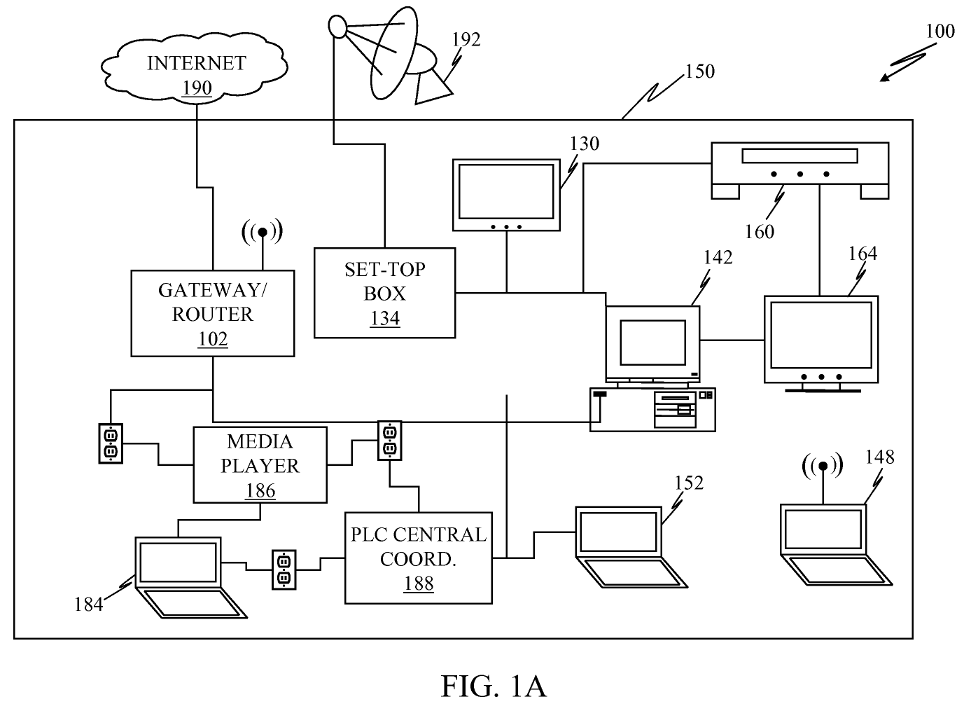

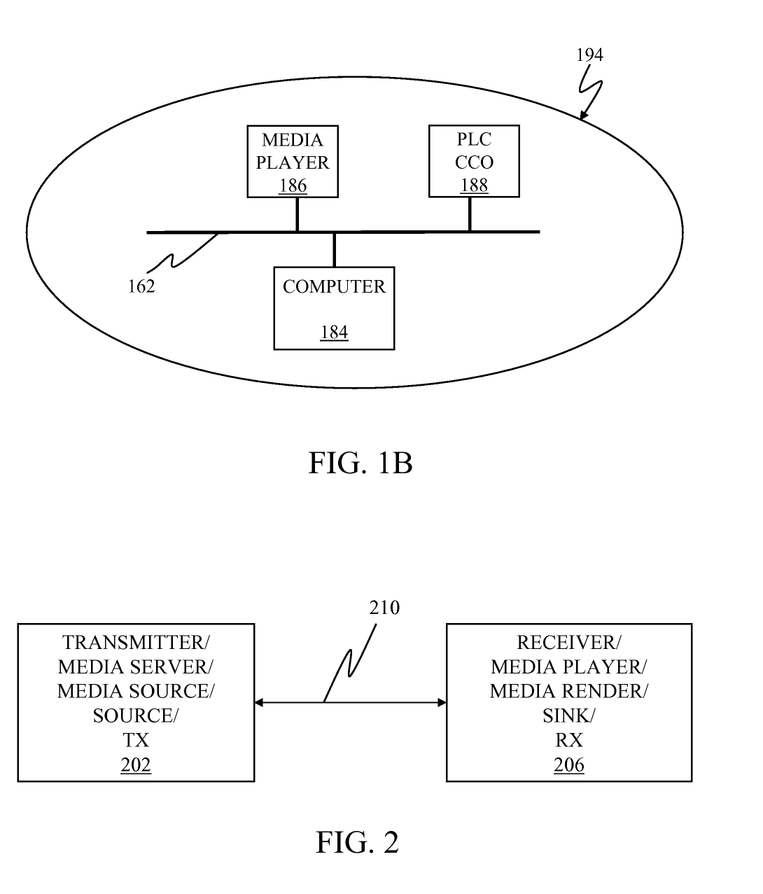

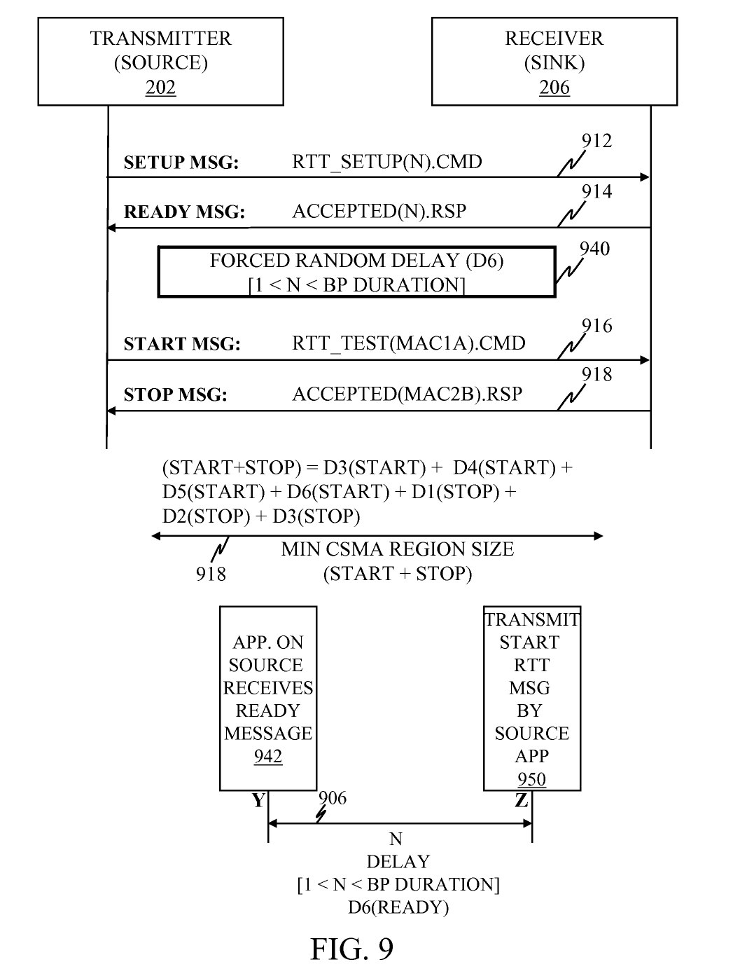

To better understand the figures, reference numerals within the one hundred series, for example, 134 and 190, are initially introduced in FIG. 1, reference numerals in the two hundred series, for example, 202 and 206, are initially introduced in FIG. 2, and so on and so forth. So, reference numerals in the nine hundred series, e.g., 904 and 942, are initially introduced in FIG. 9.

Digital Transmission Content Protection (DTCP) provides content protection for the transfer of digital contents within local area networks (LANs), e.g., within home networks. One way of ensuring copy protection is by localizing the transmission or distribution of these protected contents, i.e., constraining the transfer of protected content within a home and personal network space. This localizing to a local or an approximate local environment via proximity detection thus prevents anonymous, unauthorized, “hot-spot”-based sharing of content and unauthorized downloading to the Internet. This DTCP-IP proximity detection, for example, imposes a timing test to ensure that the round-trip time for a pair of IP packets is sufficiently short, e.g., less than 7 ms, thereby indicating that the path between the endpoints—transmitter and receiver—are sufficiently close or near each other. The proximity detection in DTCP-IP 1.1, for example, is called Additional Localization (AL) via RTT (Round Trip Time).

MICROSOFT™ Windows™ Media Digital Rights Management (WMDRM) for network devices, a digital rights management technology, is another digital content protection framework that may apply to the embodiments of the present invention. Typically, WMDRM encrypts content and binds the content to the individual device in which the content was first demodulated. Similar to DTCP, WMDRM also implements content localization via proximity detection. WMDRM, similar to DTCP-IP, is another exemplary link level content protection scheme.

The round-trip time of two packets in IP networks may depend on the network load during RTT testing. Investigations on power line communication (PLC) networks, for example, those conforming to the HOMEPLUG™ AV (HPAV) specifications or architecture, however, have uncovered a subtle timing problem that may make it very difficult or sometimes even impossible for such HPAV technologies to meet or comply with the 7 ms RTT constraint, e.g., of DTCP-IP. Even if such RTT constraint is relaxed, conditions may still be present that prevent systems, particularly those providing quality of service (QOS), to meet this RTT constraint. Investigations reveal that when an HPAV network becomes loaded with QOS-guaranteed traffic and/or when the source/transmitter, sink/receiver, or both are located on other networks, and an HPAV network is serving as a bridging network, the 7 ms RTT constraint is almost never complied with or met. The embodiments of the present invention thus address RTT proximity detection particularly within systems providing QOS. The RTT constraint, however, may not be a substantial issue for lightly loaded networks where both the source and sink applications are resident in stations on the HPAV network. HOMEPLUG™ AV is a standard or specification developed by HOMEPLUG™ Powerline Alliance.

DTCP generally assumes that technologies utilizing DTCP-IP solely employ contention-base access schemes to access the network media channel, thus, there are no or very minimal intervals during which devices are unable to contend for an opportunity to send a packet. Technologies that support guaranteed quality of service (QOS), however, typically impose time periods/intervals wherein there is contention-free access to the network medium. This means that during these contention-free periods (CFPs), only scheduled stations are enabled or allowed to transmit, and non-scheduled stations are instructed to remain silent, i.e., not contend for the channel/medium. Ironically, QOS, which is an important factor for multimedia applications, recommends the scheduling of contention-free intervals. Although the embodiments of the invention are exemplified using HPAV networks, the embodiments of the present invention may also apply to those systems, networks, devices, and methods that provide QOS, particularly to those that provide contention-free schedules or allocations. Similarly, the embodiments of the present invention may also apply to protection mechanisms that utilize proximity detections, similar to DTCP and WMDRM.

In one aspect, a determination is made as to whether the network load meets a certain defined condition, and if such condition is complied with/satisfied, the RTT test is performed with a forced time delay. If the defined condition, however, is not met, the RTT test is initiated without implementing a time delay. Various other embodiments are discussed below.

FIG. 1A is an exemplary diagram of a system 100 wherein digital content, such as audio and/or visual data, are transmitted according to some embodiments of the invention. In this exemplary embodiment, a home or local network 150 includes a number of consumer electronics, including a set-top box 134, a digital television (DTV) 130, a personal computer (PC) 142, a digital video or versatile disc (DVD) player 160, a monitor 164, a wireless computer laptop 148, a gateway/router 102, a media player 186, computers 184, 152, and a power line central coordinator 188, connected via various network links or segments. These various consumer electronics are typically adapted to be networked with each other. Other network consumer electronics may include, but are not limited to, stereo systems, digital cameras and camcorders, multimedia mobile phones, personal digital assistants, and wireless monitors. The local network 150 comprises various networks—e.g., power line communication (PLC) networks, 802.11a wireless networks, 802.11g wireless networks, Ethernet networks, and various network segments, which may include wired and/or wireless network segments. Such network segments may include, for example, Ethernet, wireless, and PLC, or various combinations thereof. The local network 150 may be operably coupled to one or more digital content provider sources, for example, via satellite, cable, and/or terrestrial broadcast 192 or via an external wide area network, such as the Internet 190. Digital content thus may be received from content providers via the Internet 190, through, for example, a gateway router 102, or via broadcasts through a set-top box 134. In this exemplary embodiment, the various consumer electronics conform to the DTCP framework, thereby enabling protected transmission of contents within the home. Other content protection frameworks may also be used, particularly those that includes data localization as part of its protection scheme.

If a consumer, for example, requests an on-demand viewing of a certain movie, this movie content may be broadcasted via satellite 192 and be received by the set-top box 134. The consumer may watch this movie at that consumer's DTV 130. The set-top box 134 functions as a source/transmitter/media server/media source while the DTV 130 is a sink/receiver/media player/media renderer. A proximity detection challenge or test is going to be exchanged between the set-top box 134 and the DTV 130, thereby to ensure that the content is distributed in a local or approximate local area.

FIG. 1B is a high-level exemplary diagram of a PLC network 194 that conforms to the HPAV specification. This network 194 may be incorporated or be part of the system 100 in FIG. 1. Power line communication (PLC), sometimes also called broadband over power line (BPL), is a wire-based technology—which typically uses medium and low voltage power lines 162 for data communications. These power line networks include networks created by using electrical wirings, for example, in homes and buildings. In this exemplary embodiment, the media player 186, computer 184, and central coordinator 188 (CCO) are connected via power line communication network segments 162.

A PLC network 194 is typically a centralized network that is controlled and managed by a central coordinator (CCO) 188. The CCO in general controls bandwidth, network scheduling, and time allocation of all stations or devices 186,188,184, within the PLC network 194. A CCO 188 may also control and schedule its own network activities. Stations that may be connected to this PLC network 194 include devices such as TVs, VCRs, computers, game consoles, sound systems, information appliances, home audio equipment, or any other device that is PLC-enabled or is able to communicate via the power lines for the power line-based network examples.

In this exemplary embodiment, beacons are broadcasted by the central coordinator 188 informing the devices within the centralized network when they are able transmit. In this embodiment, a beacon period may consists of several regions, which may include contention-based time regions, wherein the devices are free to contend for channel, contention-free time regions, wherein only scheduled or allocated devices may transmit, and stayout time regions, wherein scheduled or allocated devices are instructed to be silent, i.e., not transmit during those specified time intervals. In some embodiments, a beacon period also has a beacon time region allocated so that the centralized coordinator may transmit its beacon to inform the network devices of network schedules and allocations.

FIG. 2 shows a block diagram of two exemplary devices exchanging content in a protected manner. In the DTCP framework, for example, a sender, transmitting device, or transmitter (TX) is typically referred to as a source 202 and a receiving device or receiver (RX) is typically referred to as a sink 206. In some embodiments, a device may function both as a TX and an RX. A TX 202 is also sometimes referred to as a “media server,” while an RX 206 is sometimes referred to as a “media player” or a “media renderer.”

A source/TX 202 sends digital content to the sink/RX 206 typically over a network 210. Typically, the TX functions as a media server while the RX functions as a media player, enabling the consumer or user to view or listen to the presented content. Contents transmitted via the network 210 may include various media formats, including, but are not limited to, DivX™, MPEG, AVC/H.264, WMV9, AAC, and JPEG. Such digital content may include videos, e.g., movies, audios, e.g., songs/music, images, or combinations thereof.

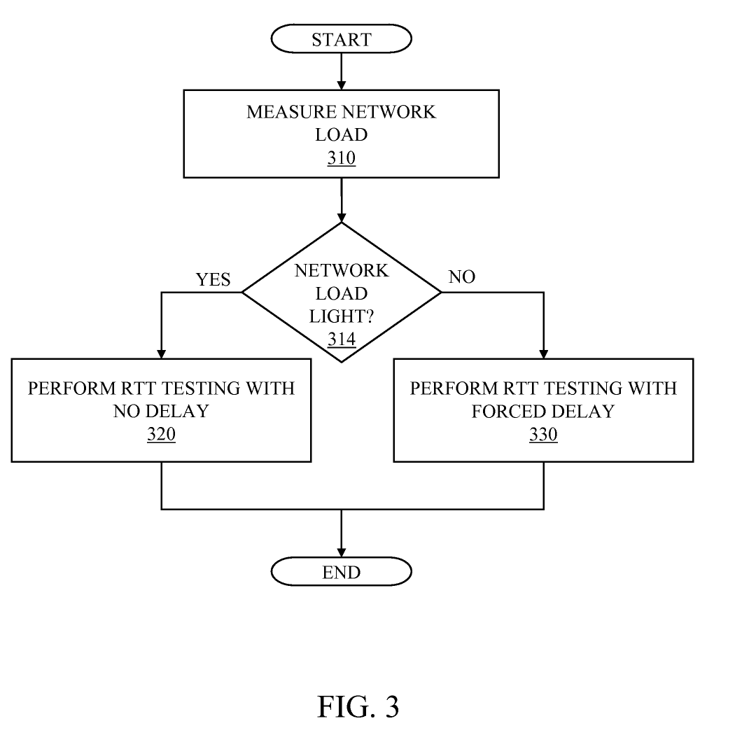

FIG. 3 is a high-level flowchart showing an exemplary embodiment of the present invention. In the first operation, the system measures the network load (step 310). If the network is light, based on a defined condition, RTT is performed without any forced delay (step 320). This RTT test 320 is without any forced delay and is similar to the conventional RTT test, e.g., as described in DTCP Volume 1 Supplement E Mapping DTCP to IP: Version 1.1 (Informational Version). In some embodiments, the load is considered light 314 if the network measurement load time delay is less than 7 ms, similar to the RTT constraint of DTCP-IP. This condition 314, however, may be altered based on implementation issues, e.g., changing the condition to 5 ms and/or having the condition based on the number of packets received, etc. On the other hand, if the network load is not light, the RTT is performed with a forced delay (step 320). The consumer may optionally be notified that there may be a slight delay when the RTT test with forced delay is performed.

The RTT test with forced delay 330 is typically employed in loaded networks, e.g., those that allocate contention-free periods (CFPs) to provide QOS. The network load measurement thus ensures that forced delays are not introduced on networks that are likely to meet the 7 ms RTT constraint 320. Forced delays are thus typically introduced when such delays may assist the devices to meet the RTT constraint. The forced delays during RTT tests are employed to time the RTT test in such a manner that generally the RTT commands are proximate to one or more contention-based access intervals, thereby facilitating complying with the 7 ms RTT constraint. Furthermore, the size of contention-based intervals may be modified.

In some embodiments of the invention, the process of measuring the network load is performed using a “Ping-like” program. Ping is an example of a utility tool or a network program to generally determine whether a specific IP address is accessible. Generally, ping works by sending a packet to the specified address and waiting for a reply. In networks complying with the Digital Living Network Alliance (DLNA™) guidelines, DTCP-IP, for example, may be used as a link protection mechanism for content transmission between home devices. The Transmission Control Protocol (TCP)/IP protocol suite contains an Internet Control Message Protocol (ICMP) stack. In other embodiments, a TCP/IP stack implemented in an operating system (OS) kernel includes an ICMP handling module, thus the response for ICMP messages may be very fast. The embodiments of the invention utilize the ICMP echo request and the ICMP echo reply to determine or assess the load on the network. Both ICMP echo request and echo response messages may be transmitted and received by IP hosts, including devices complying with the DLNA guidelines. In some embodiments, the network load measurement may be replaced by any other methods or processes that are able to measure network load.

### Internet Control Message Protocol (ICMP) and ICMP Echo

Internet Control Message Protocol (ICMP) is described in RFC 792 and is a protocol integrated with IP. Two of the ICMP messages are the ICMP echo request and the ICMP echo reply. These two ICMP messages typically form a request-response pair. ICMP messages are typically constructed at the IP layer. The IP layer typically encapsulates the appropriate ICMP message with a new IP header, and thus ICMP messages may be delivered as part of a basic IP header. ICMP echo message is type “8,” while the echo reply message is type “0.”

In general, an ICMP echo request or echo reply message may include a number of fields, of which some of these exemplary fields according to the embodiments of the invention are listed in Table I.

TABLE I
Exemplary ICMP Echo Request and Echo Reply Format:

| ICMP Field: | Brief Description: |
|---|---|
| Addresses | The address of the source in an echo message is the destination of the |
| | echo reply message. To form an echo reply message, the source and |
| | destination addresses are reversed, the type code change to “0” (i.e., |
| | echo reply), and the checksum recomputed. |
| Code | Value = “0” |
| Type | “8” = Echo Request |
| | “0” = Echo Reply |
| Checksum | The checksum is the 16-bit one's complement of the one's |
| | complement sum of the ICMP message starting with the ICMP Type. |
| | For computing the checksum, the checksum field is first set to zero. |
| | If the total length is odd, the received data is padded with one octet |
| | of zeros for computing the checksum. This checksum may be |
| | replaced in the future. |
| | In some embodiments, when the checksum is computed, the |
| | checksum field is first set to zero. When the data packet is |
| | transmitted, the checksum is computed and inserted into this field. |
| | When the data packet is received, the checksum is again computed |
| | and verified against the checksum field. If the two checksums do not |
| | match, then an error has occurred. |
| Identifier | If Code = “0,” an identifier to aid in matching echoes and replies, |
| | may be zero. |
| Sequence | If code = 0, a sequence number to aid in matching echoes/echo |
| Number | requests and replies, may be zero. |
| Description/Data | The data received in the echo message are typically returned in the |
| | echo reply message. The identifier and sequence number may be |
| | used by the echo request sender to aid in matching the replies with |
| | the echo requests. For example, the identifier may be used like a port |
| | in TCP or UDP to identify a session, and the sequence number may |
| | be incremented on each echo request sent. The echoer, receiver of |
| | the echo request, returns these same values in the echo reply. |
| | This is typically variable length, and may be implementation-specific |
| | data. |
| | Code 0 may be received from a gateway or a host. |
| | In some embodiments, a TIMESTAMP of when the echo request |
| | message is sent may be included as part of this field. |

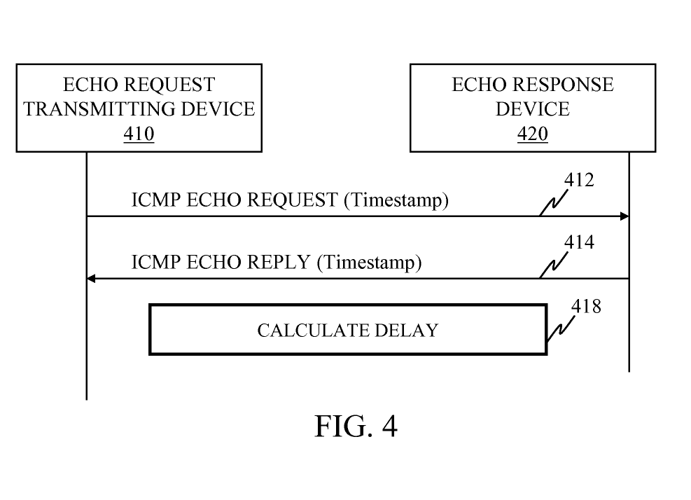

FIG. 4 shows a data flow of exemplary echo request and echo reply messages according to some embodiments of the invention. The network load testing in some embodiments is performed by transmitting an ICMP echo request message 412 from a transmitting device 410 to another device 420 that transmits back an ICMP echo reply message 414 and calculating the time difference or delay 418 from the time the echo request message is transmitted to the time the corresponding echo reply message is received at the transmitting device 410.

In some embodiments, this network load measurement may be implemented by adding a timestamp in the data/description portion of the ICMP echo request message. The timestamp indicates the time when the echo request message is sent. The ICMP echo response message then copies the data/description field or portions thereof, typically including the timestamp information, such that the device, which transmitted the echo request message and which received the corresponding echo reply, is able to calculate the time difference or delay from when the echo request is sent and when the echo reply is received. In some embodiments, the time difference may be very similar to the RTT of a link protection RTT proximity detection test. Thus, the exchange of the echo request and reply messages may be utilized as an indictor of the network load. In other embodiments, a timestamp in the data/description field is not utilized, but rather the sending device maintains the timestamp when the echo request is sent and accordingly keeps track of when the corresponding echo reply is received. Based on this information, the sending device is able to calculate the time difference between the transmission and the reception of these messages.

In some embodiments, the time to live (TTL) value of an ICMP echo request message may be set to a value not greater than three (3). IP packets conforming to the DTCP-IP protocol typically assigns the value of “3” to the TTL field of the IP header. Furthermore, considering that the exemplary network load measurement process measures the two-way time delay, either the source or sink may initiate the network load measurement test without substantially affecting the time delay result. In general, the result is the same or similar independent of which device initiates the echo request message. Similarly, other digital transmission content protection scheme, e.g., WMDRM-ND, which is adapted to utilize a ping-like or ping utility may also utilize the exemplary network load measurement process described herein.

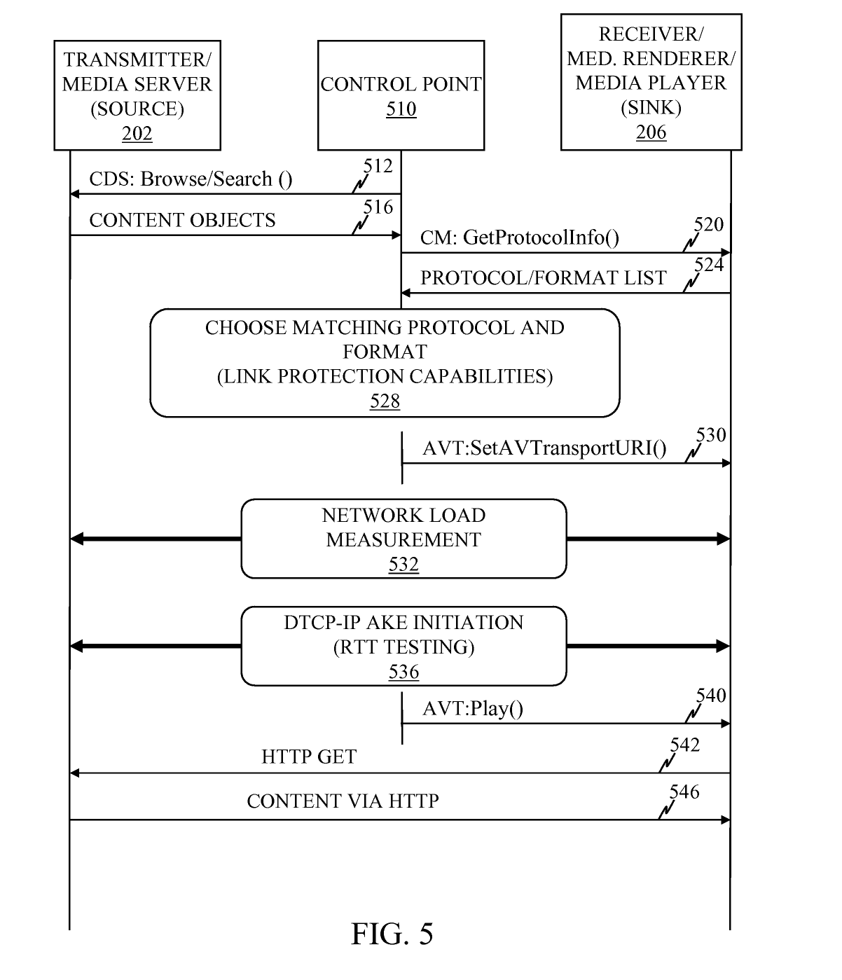

FIG. 5 is an exemplary data flow diagram showing how the exemplary network load measurement process may be used to improve the RTT proximity detection between devices. As stated above, other network load measurement process 532 may also be used within the embodiments of the invention. Examples of such network load measurement process include the utilization of other tools, like RTTometer, fping etc.

FIG. 5 shows a system with a control point 510, according to an embodiment of the invention. In many universal plug and play (UPnP) systems, a control point 510 is utilized to control the operation of one or more UPnP devices. This architecture is adapted to support arbitrary transfer protocols and content formats thereby enabling control points to transparently support new protocols and formats. In general, a control point 510 interacts with two or more devices acting as a source 202 and sink 206. The control point 510 typically configures the devices 202, 206 and triggers the flow of content, e.g., the transfer of a premium movie. Although the control point may coordinate and synchronize the behavior of the source 202 and the sink 206, the source and the sink may directly interact with each other without the intervention of the control point using an out-of-band communication protocol 532, 536. The network measure load process 532 and the DTCP-IP AKE test 536 are typically performed using an out-of-band transfer protocol.

In an exemplary embodiment, the control point 510 sends a content directory service (CDS) browse request 512 to a media server 202. In some embodiments, the receiver 206 has triggered this request to be initiated. The media server then transmits the content object information 516 to the control point. This content object information 516 includes metadata, e.g., name, artist, date created size, titles, etc. In addition, transfer protocols and data formats, e.g., JPEG, MP3, MPEG2, and MPEG4, supported by the media server for a particular content item, for example, are also sent by the source 516. The control point 510 may then request a connection manager service (CM) to obtain the protocol information 520 supported by the media player/renderer 206. A response 524 to this CM request 520 is then sent, which contains transfer protocols and data formats 524 supported by the media player 206 This protocol/format list information 524 thus indicates whether a media player is capable of rendering a specific content item. The control point then matches the protocol/format information returned by the media server 516 with the protocol/format information returned by the media player 524. The control point then selects a transfer protocol and a data format supported by both the media server and render 528.

In some embodiments, the control point may request an AVTransport service to control the flow of the associated content. The AVTransport service may transmit a service message 530, e.g., SetAVTransportURI( ), identifying the content item to be transferred. It also identifies the uniform resource identifier (URI) indicating the name and/or address of an object. In some embodiments, the media player initiates the network load measurement after the sink receives the SetAVTransportURI( ) 530 request and before the DTCP-IP authentication and key (AKE) 536 is initiated.

An out-of-band network load measurement between the media server and player is then accordingly performed 532. Similarly, an out-of-band DTCP-IP AKE function is initiated 536. RTT testing is typically part of the AKE function in DTCP-IP. Depending on the load, RTT with forced delay or RTT with no forced delay is performed 536. Assuming that the RTT time constraint is met, the control point 510 then sends an AVTransport service Play request 540 to the media player.

Using a transfer protocol, e.g., Hypertext Transfer Protocol (HTTP) GET, the content is requested 542 and then transmitted by the media server 202 to the player 206. Other transfer protocol may include, e.g., IEEE 1394 and Real Time Streaming Protocol/Real-Time Transport Protocol (RTSP/RTP). The HTTP request, transfer protocol, 542, 546 typically is a DTCP-IP link protected transport, thus, for the content to be transported the RTT constraint has to be met. After the content is transferred, the media player accordingly renders, i.e., presents or plays, the content to the viewer.

The exemplary embodiment in FIG. 5 is for illustrative purposes. Other embodiments and variations may also apply, for example, a different network load measurement function or process 532 may be performed, a different transport protocol may be used, or a control point may not be employed in the system. In some embodiments, other conditions defining when an RTT with forced delay is to be performed may also be varied, e.g., the load measurement delay has to be less than 6 ms rather than 7 ms. The network load measurement process 532 may also be an application separate from the link protected transport 542, 546. In some embodiments, the DTCP-IP AKE may be replaced by a corresponding WMDRM-ND proximity detection if the WMDRM-ND is used as the link protection scheme. In some embodiments, the network load measurement may happen at a time not immediately preceding the AKE function 536, but a not so accurate result of the network load may be obtained.

### Round Trip Time (RTT) Test/Proximity Detection with Forced Delay

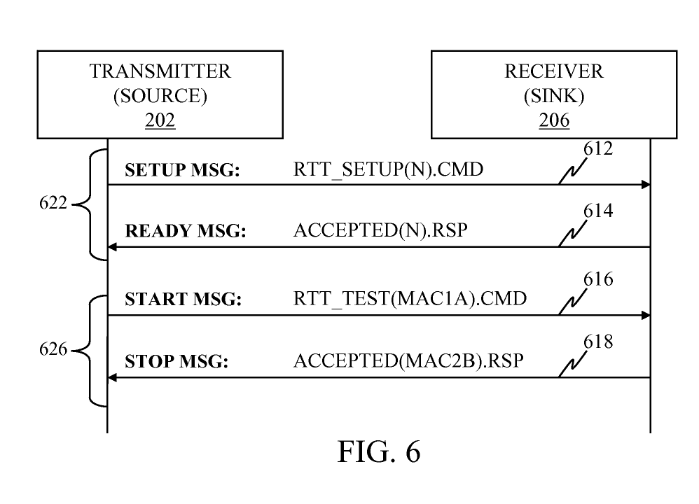

FIG. 6 is a diagram of exemplary RTT messages exchanged to determine latency between devices or RTT (see step 320 OF FIG. 3). This proximity detection challenge illustrates an exemplary DTCP-IP RTT protocol or portion thereof, according to some embodiments of the invention. This RTT proximity detection is typically performed within the challenge-response portion of the authentication and key exchange (AKE) function within DTCP. Part of DTCP is exchanging cryptographic keys, for example, by the source/TX 202 and the sink/RX 206 such that data for transmission is protected. In some embodiments, the RTT testing may be performed a certain defined number of times, e.g., 1024 times, before the source/TX and sink/RX abort, such that encryption keys are not exchanged. In some embodiments, failure to meet the RTT threshold/condition may result in the content not being sent between the TX and RX. In some embodiments, RTT messages may be exchanged to determine if a certain device is to be added to a list of approved or valid sink devices.

In general, an RTT test includes two phases—a set-up phase 622 and a measurement phase 626. The RTT procedure typically begins by sending a set-up request message, e.g., an RTT_SETUP(N).CMD 612, herein also referred as a SETUP message, from source 202 to sink 206. This SETUP message generally indicates to the sink to prepare for an RTT test. The number of retries may be established by having a value N assigned in the RTT_SETUP(N).CMD 612 message. N is typically initially set to zero and may range from 0 to a maximum permitted RTT trials, e.g., 1024 maximum retries, thus, N ranges from 0 to 1023. The number of maximum retries is then accepted by the sink 614. The ACCEPTED(N).RSP message, herein also referred as a READY message, 614 indicates to the source that the sink 206 is prepared to perform the RTT procedure.

After the N is set, the source 202 then starts the measurement phase 626. This test measures the RTT which is the time interval starting typically after the source 202 transmits the RTT_TEST(MAC1A).CMD message, herein also referred to as a START RTT/START message, 616—i.e., the initiate RTT message, indicating or triggering the initiation of the proximity test or RTT test, and terminates upon reception of the ACCEPTED(MAC2B).RSP response, herein also referred to as a STOP RTT/STOP message 618. The receipt of the response STOP RTT message indicates or triggers the completion of the RTT test. Generally, the RTT timer starts when the source sends the RTT_TEST(MAC1A).CMD 616 to the sink and stops when the source receives the ACCEPTED(MAC2B).RSP 618. The START 616 and STOP 618 messages may include parameters, such as MAC1A and MAC2B—which function as message digests, which are similar in concept to checksums. If the RTT does not meet the defined RTT or latency threshold, the RTT test may be repeated. Each time an RTT test is retried, the number of retries is tracked, such that the number of retries does not exceed the maximum allowable number of retries permitted in the system. If the maximum number of retries has been exceeded, the encryption keys or content, for example, are not exchanged.

The messages 612, 614 in the setup phase 622 are used to setup the RTT test, so that the sink is prepared to perform any appropriate computations and enable the sink to quickly send the STOP message 618 as soon as it receives the START message 616. The RTT is typically measured at the source.

Some local area networks (LANs) provide access to the medium via some sort of contention mechanism, in which all devices compete for access. Other LANs, however, attempt to provide guaranteed QOS for the support of multimedia applications. Such LANs, herein referred to as QOS LANS, preempt part of the time on the medium and allocate those times to devices to obtain QOS guarantees, thus, some time allocations are allocated for contention-free allocations. As a LAN becomes more heavily loaded with QOS guaranteed traffic, the amount of time left for contention based traffic, e.g., both traditional “best effort” traffic and prioritized traffic, becomes smaller. As the time available for CSMA shrinks, it becomes increasingly difficult for QOS LANS to ensure that the RTT time requirement of DTCP-IP, for example, is met.

QOS LANs that may encounter this RTT problem may include HPAV, IEEE 802.15.3, and IEEE 802.11e with hybrid coordination function (HCF) controlled channel access (HCCA) mode. Because the time allocation methods are unique for each of these QOS LAN technologies, the remainder of this problem description is described using QOS LANS conforming to the HPAV specification, but the RTT problem may impact other QOS LANs as well.

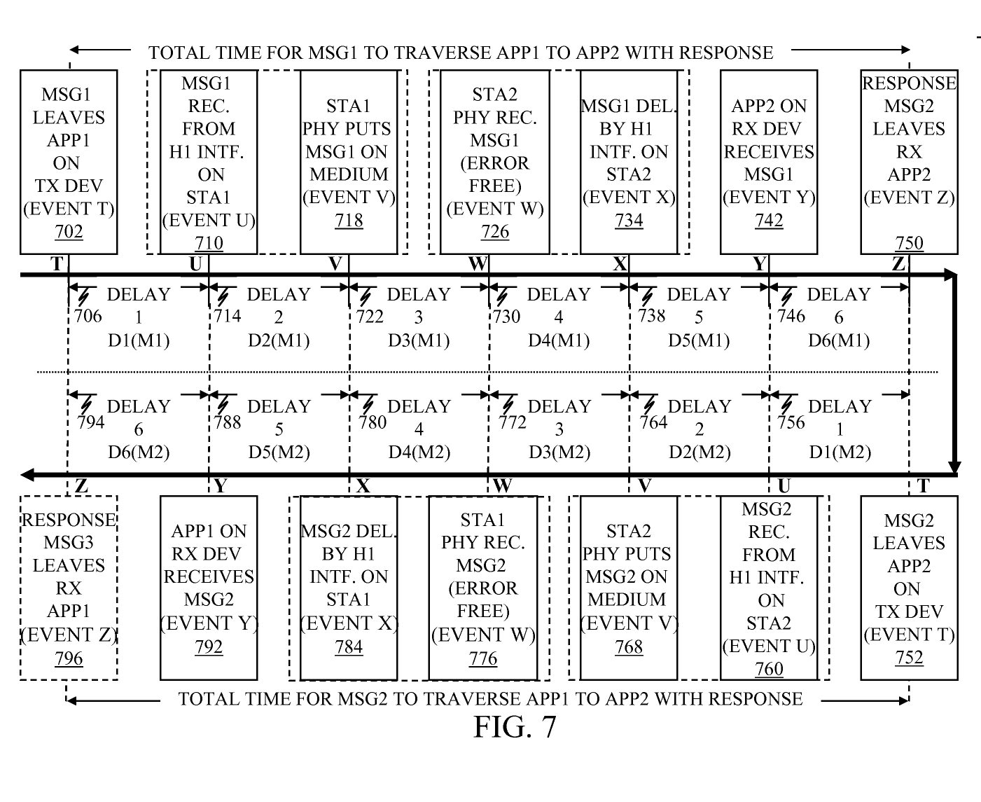

FIG. 7 shows time delays typically encountered when a message is sent from one application to another. The top portion generally shows the time incurred for a message, e.g., MSG1, to travel from an application, e.g., APP1, to another peer application, e.g., APP2, when a portion of the trip is via a HPAV network. The bottom portion generally shows the time delay incurred for a response message, e.g., MSG2, to travel from APP2 to APP1. Response delays are also shown. The events are labeled with letters T through Z. There is typically a delay (latency) between each pair of sequential events. Examples of messages may include the START message 616 as MSG1 and the STOP RTT/STOP message 618 as MSG2. The delays between each sequential event may include the following:

DELAY 1: Delay 1 (D1) 706 is the time duration that elapses when the message, MSG1, is sent by the application, APP1, 702 (event T) and when MSG1 is received, for example, by an H1 interface of a station, e.g., STA1 (event U) 710. Event U 710 may be construed as when the message is, for example, received by a chip, modem, adaptor, or entity supporting the PLC network or HPAV specification. In some embodiments, the application on the transmitting device 702 is not resident on the device, which has the H1 interface or HPAV chip/AV chip, e.g., an adapter or modem. Delay 1 typically has two components:

a) Protocol Stack Transit Time: The time consumed in processing the message, e.g., TCP/User Datagram Protocol (UDP) encapsulation, Internet Protocol (IP) encapsulation, and Ethernet encapsulation. The protocol stack transit time is typically small, but may depend upon the efficiency of the implementation.

b) Interface Transit Time: The time consumed for the message to transit between the application, APP1, and the H1 interface. The interface transit time is typically small if the application and the H1 interface are resident in the same device or station; e.g., this delay may include buffering time and other time durations consumed by implementation-dependent steps. If the application and the H1 interface are, however, on different devices—for example, the application is on a device on a foreign network, e.g., a non-PLC network, and the H1 interface is on a bridging station—then the delay may potentially be large. The size of the interface transit time may also depend upon the deployment of the source and sink at run time, which may be beyond the control of the HPAV network. FIG. 7 shows that the H1 interface is on a device 710 separate from the application 702.

DELAY 2: Delay 2 (D2) 714 is the time that elapses between the event U 710, when the message is received by the HPAV chip, and when the chip puts the message onto the power line medium (event V) 718. Delay 2 714 is typically substantially and in some embodiments completely due to message processing, e.g., the time consumed in classifying, framing, segmenting, encrypting, and queuing delays. Delay 2 714 is typically small and its duration may be relative to the other delays and/or may depend on implementation.

DELAY 3: Delay 3 (D3) 722 is the time consumed to move the message from the transmitter to the receiver, e.g., from STA1 to STA2 790—from event V 718 to event W 726. Delay 3 of an exemplary embodiment has typically at least three components:

a) Channel Access Latency: The time consumed while waiting for an opportunity to put the message on the power line network. This time may include failed contention attempts. Channel access latency may be estimated statistically and varies between 0 and (Time(Beacon Period)−Time(CSMA Region)). Channel access latency is a key cause of the problem faced by LANs that guarantee QOS. Beacon periods are typically system dependent, e.g., approximately 100 ms in a typical 802.11 network, 33.3 ms for a 60-cycle power line system, and 40 ms for a 50-cycle power line system.

b) Media Transit Time: the time that elapses during the physical transmission of the packet. This media transit time includes the time consumed in contending for power line channel. In this exemplary embodiment, it is assumed that the channel or medium is obtained after the first contention attempt. In some embodiments, the media transit time may be a variable because it may depend upon the modulation of the signal and the tone map used. This media transit time delay is typically bounded by a worst case, e.g., ROBO mode, and a best case, e.g., coherent 1024 QAM modulation and full—all tones used—tone map.

PLC networks conforming to HOMEPLUG™ AV specification or other HOMEPLUG™ specification variations, employ typically three modes of communication, called ROBO modes, for several purposes, including beacon and data broadcast and multicast communication, session setup, and exchange of management messages. All ROBO modes typically utilize quadrature phase-shift keying (QPSK) modulation, along with a ½ rate turbo convolutional code. These ROBO modes may include 4.9226 mbps, 9.8452 mbps, and 3.7716 mbps PHY rates.

c) Error Correction Time: the time consumed during retransmissions, if any, of portions of the message that may have been received in error because of interference or other impediments.

DELAY 4: Delay 4 (D4) 730 is the time that elapses between events W 726 and X 734, while the MAC/PHY on the receiving AV chip, for example, reconstitutes the message and prepares the message for the application. Delay 4 (D4) 730 is typically substantially or completely due to message processing, e.g., decrypting and reassembling the message. Delay 4 is typically small and its duration may be relative to the other delays and/or may depend on implementation.

DELAY 5: Delay 5 (D5) 738 is the time that elapses between the event X 734, when the receiving chip delivers the message at the H1 interface, and the event Y 742, when the message is actually received by the application, APP2. Delay 5 typically has the same components as Delay 1 and the same comments and discussion apply. The actual values of the delay components, however, may differ depending upon the receiving device's topology.

DELAY 6: Delay 6 (D6) 746 is the time that elapses while the receiving application is processing the message and preparing the response. At the end of this interval, event Z, 750 the receiving application, APP2, becomes the transmitting application as the response message begins its trip back to the original transmitter, i.e., event Z(Msg n), e.g., Event Z(MSG1) 750, is generally the same event as Event T(Msg (n+1)), e.g., event T(MSG2) 752, as shown.

Thus, in this exemplary embodiment, the response message, MSG2, from event Z 750 that is going to be sent back to APP1 by APP2, for example, typically incurs the similar time delays as when APP1 was transmitting MSG1 to APP2, i.e., D1(MSG1) 706+D2(MSG1) 714+D3(MSG1) 722+D4(MSG1) 730+D5(MSG1) 738—without accounting for a response message, event Z 750, thus no delay 6. Thus, the delay incurred for the response message, MSG2, to travel from APP2 752 to APP1 792 on the receiving device is D1(MSG2) 756 (from event T 752 to event U 760)+D2(MSG2) 764 (from event U 760 to event V 768)+D3(MSG2) 772 (from event V 768 to event W 776)+D4(MSG2) 780 (from event W 776 to event X 784)+D5(MSG2) 788 (from event X 784 to event Y 792). If a response, e.g., MSG3, is to be transmitted 796, a delay 6, D6(MSG3), 794 may be incurred.

Let us assume for illustrative purpose that MSG1 is the START RTT message 616 and MSG2 is the STOP RTT message (FIG. 6). Delay 6 (D6) 746 is typically small during an RTT test. The purpose of the SETUP message 612 and the READY message 622 is to minimize the size of D6, delay 6, 746 which is typically the only one instance of D6 during an RTT test—the RTT clock is stopped at the very beginning of D6(STOP), i.e., when the application sending the START message 710 receives the response message, STOP message, which is event Y 792. Receiving the STOP message indicates and/or triggers the completion of the RTT test.

For illustrative purpose, the events T, U, V, W, X, Y and Z are assumed to be point events that have no latency. All latency is assumed to be accounted for in the delays that occur between the events. The 7 ms timing constraint for RTT means that the total sum of Delays 1 thru 6 for the START RTT message 616 plus Delays 1 thru 5 for the STOP RTT message have to be ≦7 ms. That is:

RTT=D1(START)+D2(START)+D3(START)+D4(START)+D5(START)+D6(START)+D1(STOP)+D2(STOP)+D3(STOP)+D4(STOP)+D5(STOP)≦7 ms (see FIG. 7)

In some embodiments, the largest components of the RTT may be the interface transit times of delays 1 and 5 and the channel access latency of delay 3.

### Channel Access Latency (Part of Delay 3)

Channel access latency may be an issue, e.g., adversely affects throughput and quality of service, on all LANs and may get worse as the load on the LAN increases. DTCP-IP, in some aspects, addresses this issue by providing the LAN 1,024 retry opportunities. In QOS LANs that preempt CSMA traffic to provide guaranteed QOS, the channel access latency may be even longer.

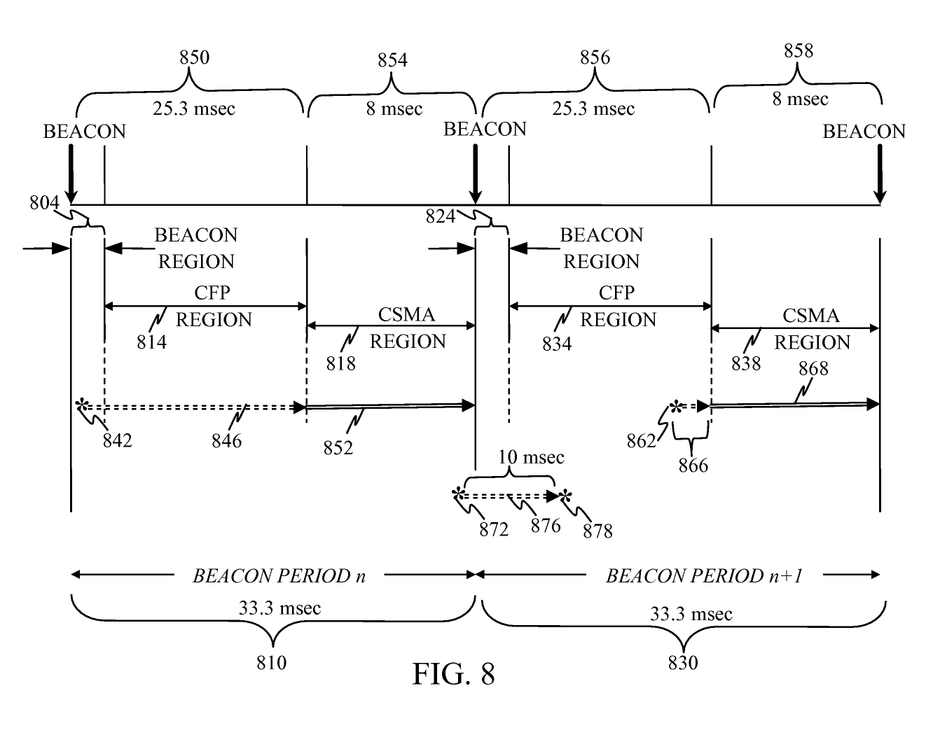

FIG. 8 shows two exemplary consecutive beacon periods 810, 830 for an uncoordinated HPAV network. FIG. 8 is discussed in conjunction with FIGS. 6 and 7. These two beacons, for example, may be broadcasted by a central coordinator of the HPAV or PLC network to announce the beacon periods as well as network scheduling and allocation information.

In this exemplary embodiment, there is one power line network and, thus, one central coordinator (CCO) operating in the uncoordinated mode. A CCO operating in the uncoordinated mode with no QOS typically specifies a beacon region with at least one beacon slot to transmit its beacon and a CSMA region for the remaining of the beacon period. In some embodiments, it optionally establishes one or more CFP regions, particularly when QOS traffic is supported. A central coordinator operating in the uncoordinated mode typically generates its own timing and transmits its periodic beacon independently of other networks. The beacon announces the beacon period of that network indicating network scheduling and allocation information. The beacon is typically broadcasted during a beacon time region 804, 824. No other stations in the network, except the centralized coordinator, typically transmit during these beacon regions 804, 824. Let us assume that each beacon region 804, 824 is approximately 0.3 ms in duration.

This exemplary network is a simple case where there are no neighbor networks and no fragmentation of the regions within the beacon period. Typically, if neighbor networks are considered, the RTT problem may be exacerbated. A neighbor network is typically another network controlled by another power line central coordinator (e.g., see FIG. 1B). The central coordinator of each PLC network 194, for example, may coordinate with each other, i.e., operate in the coordinated mode. For example, if one PLC network 194 assigns a contention-free period within t1 to t6, the other neighbor PLC network, to avoid conflict, assigns a stayout region, i.e., do not transmit, within t1 to t6, assuming the timing of their beacon regions are the same.

In FIG. 8, it may be assumed for this example that all of the RTT messages, e.g., SETUP 612, READY 614, START 616, and STOP 618 messages, are transmitted during a CSMA period, and are transmitted at the highest CSMA priority available, e.g., priority 3, within this exemplary power line network. This exemplary power line network has a beacon period of 33.3 ms 810, 830. Each CSMA/contention-based access region 818, 838 is 8 ms in duration. The time interval 856 between the two CSMA regions 818, 838 is thus 25.3 ms. Each CFP region 814, 834 is approximately 25 ms in duration. QOS may be guaranteed by allocating time periods within the beacon period to contention-free allocations or contention-free periods 814, 834. Thus only station(s) or device(s) allocated these CFP intervals 814, 834 are free to transmit during those times.

To generally meet the RTT constraint, the START RTT message 616, for example, should be received near 862 the CSMA period 838, so that only a short delay 866 is incurred before contention access 868 is available to enable the device, e.g., the sink, to transmit the STOP RTT message 618 back to the source, for example.

If the START RTT 618 message, however, is received at the H1 interface 734 during the beacon region 842, a delay 846 of almost 25 ms has to be incurred before the earliest time the START message may be transmitted to the application at the sink 742, i.e., wait for the beacon region 804 and the CFP region 814 to expire, before the H1 interface or HPAV chip is able to transmit or at least contend 852, 818 for the channel. The channel access latency alone thus results in exceeding the maximum RTT constraint by approximately more than a factor of 3 and thus, this particular RTT test fails.

Although the DTCP specification allows for 1024 retries, it may be argued that at least some of the START RTT messages may likely arrive early in the CSMA, e.g., considering the arrival times may be randomly distributed over the entire beacon period. This, however, may not be true for all cases, considering that the timing of when the source sends the START RTT message 616 is typically not controlled and is not random. It may be assumed that the source sends the START RTT 616 message at some substantially fixed interval after the source receives the READY 614 message. Looking at FIG. 7, for example, assume that MSG1 is the READY message and MSG2 is the START message. There is thus a delay of D(READY−START)=D4(READY) 730+D5(READY) 738+D6(READY) 746+D1(START) 756 between when the READY message is received at the PHY 726 and before the START message arrives at the transmitting AV modem 760 and the channel access latency for the START message may approximately begin. The D6(READY) delay 746 is typically the delay incurred between when the application receives the READY message and when the application sends a response message, e.g., the START RTT message 616. In some embodiments, D(READY−START)=D4(READY) 730+D5(READY) 738+D6(READY) 746+D1(START) 756+D2(START). Thus, the arrival of the START RTT message is not randomly distributed oven the beacon period, but rather is dependent upon when the READY message is received at the source.

Thus, in some embodiments, to potentially meet the RTT constraint, both the START and the STOP RTT messages have to be transmitted in the same CSMA region, e.g., the first CSMA region 918, considering that the interval 856 between the two consecutive CSMA regions 818, 838 is over 25 ms, i.e., substantially greater than 7 ms. Sending the START and the STOP RTT messages in different CSMA regions 818, 838 results in failing the RTT test.

If the READY message, however, is sent during the CSMA 818 region in the first beacon period n, BP(n), 810, then both the START RTT and the STOP RTT messages have to be sent in the same CSMA region, e.g., in the first CSMA region 818 or during a subsequent CSMA region 838 of the other beacon period, e.g., BP(n+1) 830 so that the RTT test may potentially succeed. If the START RTT and the STOP RTT messages, however, are sent during the CSMA 818 of the first beacon period, e.g., BP(n), i.e., when the READY message is also sent, then the CSMA region 818 has to be of sufficient duration to accommodate the transmission of the READY, START RTT, and STOP RTT messages and their accompanying delays, i.e., (READY+START+STOP)=D3(READY)+D4(READY)+D5(READY)+D6(READY)+D1(START)+D2(START)+D3(START)+D4(START)+D5(START)+D6(START)+D1(STOP)+D2(STOP)+D3(STOP). The CSMA region thus in this exemplary embodiment has to be of sufficient duration to consider the D3 starting from the time when the READY message is on the PHY ready for transmission and ending when the STOP message is received on the PHY error free.

If the START RTT 616 message, however, is not received until another CSMA region, e.g., BP(n+1) 838, then the CSMA region 838 may need to be of sufficient duration to accommodate the START RTT and the STOP RTT messages, i.e., (START+STOP)=D3(START)+D4(START)+D5(START)+D6(START)+D1(STOP)+D2(STOP)+D3(STOP). Thus, the CSMA region accommodates the delays starting from the D3 after the START message is on the PHY ready for transmission and ending when the PHY associated with the source has received the STOP message error free.

To ensure, however, that the START RTT message 616 does not arrive during the beacon region 804, 824 or the CFP region 814, 834, where no contention-based access is enabled or allowed, a delay may be imposed D(READY−START) as discussed above. Without such a requirement, it is probable that the START RTT message may be received before the CSMA period starts and thus that RTT test may fail. The delay, D(READY−START), may have to be dynamically changed because such delay typically depends upon the size of the non-contention based interval between two succeeding CSMA regions. The imposition of such delay, however, may not be practical in some embodiments even if the source application is resident on a power line station, e.g., with the HPAV chip, because if the source is bridged from another network, the source may not be aware or on notice that an HPAV network or a network providing QOS is involved. Note, that the impracticability stems not from the size of D(READY−START), but rather is due to the delay D(READY−START) being relatively static.

To illustrate this embodiment, if the interval D(READY−START) is approximately 10 ms 876, then the START message 878 may always arrives during the CFP region 834—in fact, more than 15 ms before the end of the CFP region. This is because the CSMA region 818 is only 8 ms 854 and it is within this interval that the READY message 872 is sent, thus, the delay 876 results in the START message 878 arriving at the CFP region 834. Thus, the RTT timer expires even before the HPAV modem or chip associated with the source device is able to contend for channel to transmit the STOP message.

Thus, based on such analysis, to improve QOS LANs to meet the RTT constraint, the CSMA region(s) on such QOS LANs have to be of sufficient duration to accommodate the READY, START RTT, and STOP RTT messages and all the related delays from D3(READY) through D3(STOP), inclusive.

If the delays are large, as they may be if either the source or sink application resides outside the HPAV network, the CSMA region should be sufficiently large and even potentially larger in order to be able to accommodate existing connections without disrupting their own QOS guarantees. Furthermore, the design of the network may also include one or more entities on the HPAV network adapted to recognize the RTT-related messages, e.g., SETUP, READY, START RTT, and STOP RTT thereby providing such RTT-related messages with special treatment or priority. In some embodiments, merely having a priority of CAP3, the highest priority within the CSMA region, may not ensure that the READY, START RTT, and the STOP RTT messages are transmitted during the same CSMA region.

Addressing the timing relative to the SETUP message, if it is assumed in this example that the SETUP message is received at the H1 interface at a random time during the beacon period, then there is a highest probability that the SETUP message may be transmitted at or near the beginning of a CSMA region. If the computation time at the sink is relatively short such that the response READY message arrives at the H1 interface at the same CSMA region, the READY message may likely be sent in the same CSMA region as the SETUP message and, by the same rationale and discussion above, the CSMA region has to be of sufficient duration such that the CSMA region is able to accommodate (SETUP+READY+START+STOP), i.e., all delays from D3(SETUP) through D3(STOP) inclusive.

In some embodiments, issues may arise if some of the SETUP, READY, START, and STOP messages are transmitted within a CFP period. In the current implementation of HPAV networks or design, there are no provisions for ensuring that two time allocations be arbitrarily near to each other, i.e., to ensure that the transmission opportunities for the START RTT and STOP RTT messages occur within 7 ms of each other. As discussed above, the delay when the START RTT and STOP RTT messages are transmitted includes the delays D3(START) through D3(STOP), inclusive. Even assuming that the HPAV architecture may be modified to enable the relative positioning of two transmission opportunities (TXOPs) within the CFP region, because many of the delays include implementation or topological dependent components, the scheduled interval between TXOP(START) and TXOP(STOP) may have to be determined heuristically. This heuristic determination may more likely introduce additional complexity.

Furthermore, a heuristic solution may further complicate the problem of meeting the RTT constraint by introducing an additional timing problem, e.g., the delay incurred to revise the persistent schedule, i.e., a schedule persistent within a number of beacon periods. Persistent schedules typically utilize a couple of beacon periods for message exchanges to request the new schedule plus several beacon periods while the central coordinator announces the new schedule and counts down the old schedule, i.e., informs the devices within the network of the new schedule and a count down when the old schedule is no longer applicable.

Furthermore, because the CFP TXOPs are fixed in time—the periodicity of the CFP TXOPs for a given connection is so deeply embedded in the architecture that it is very difficult to change—the prescribed precision of when messages arrive relative to their assigned TXOP may even be greater than for the CSMA region: if a message arrives early, the message waits for its CFP TXOP whereas in the CSMA period it may possibly be sent sooner; if the message arrives late, the messages misses its TXOP whereas in the CSMA region, the message may still be possibly sent.

Considering that the timing relationship of the READY message to the START RTT and STOP RTT messages may cause timing problems for any LANs that reserve periods of time for non-contention-based access, e.g., QOS LANs, it is ironic that the systems that preempt CSMA are the systems that provide guaranteed QOS—precisely the networks wherein DTCP is most likely employed.

There are a number of embodiments that may address the RTT constraint discussed herein. In some embodiments, the minimum size of the CSMA region is typically of sufficient size to enable the appropriate RTT-related messages be transmitted in a single CSMA period. This applies to QOS LANs and particularly those conforming to the HOMEPLUG™ AV specifications.

### EXAMPLE 1

### Forced Delay RTT Test

FIG. 9 is an exemplary diagram of an exemplary RTT with forced delay 330 (see FIG. 3) embodiment of the present invention. The RTT test of the present embodiment starts with a SETUP message 912, similar to that shown in FIG. 6. The READY response 914 is then sent by the application at the sink 206 to the source 202, indicating that the sink is ready to perform the RTT test.

After receiving the READY message 914, the source 202 then consumes a forced random amount of time 940, N, where N is the interval, e.g., [1 time unit<N< Beacon Period Duration] (N is >=1 time unit and <the beacon period duration), before the source application 750 transmits the START RTT message 916. Such time unit, for example, may be in ms or any time unit applicable or appropriate to that beacon period. In some embodiments, the forced random amount of time may be greater than one beacon period, e.g., two and a half times the beacon period duration. In more detail, thus, once the application on the source receives the READY message 942 (see FIG. 7 742), the source or application consumes a random N time, i.e., delay 6, D6(READY) 906 (see FIG. 7 746), before the application responds with the START message 950 (see FIG. 7 750). The sink accordingly transmits a STOP RTT message 918—indicating or triggering the completion of the RTT test, once it receives the START RTT message from the source.

Providing a random delay thus breaks the relationship between the READY message and the START RTT message, thereby relaxing the requirement on the size of the CSMA region. In this embodiment, the size of the CSMA region 918 may be of sufficient size to accommodate the delays from D3(START) to D3(STOP), inclusive—i.e., (START+STOP). This exemplary embodiment may apply to DTLA and DLNA technologies. Considering that other technologies, e.g., wireless with QOS networks, have different repetition intervals, the actual range of N may need to be longer or adjusted to accommodate other intervals, including delays, of other technologies.

FIG. 9 shows exemplary RTT test typically applied using DTCP-IP and/or WMDRM for network devices (WMDRM-ND). In some embodiments, the SETUP message and/or the READY message may be eliminated and be replaced by other messages. For example, the embodiments of the present invention may apply to systems that simply employ START and STOP messages. The forced delay 940, which may be random, is applied between the reception of a “failed” STOP message and the next START message, i.e., the STOP message is analogous to a READY message for the next RTT test message pair—indicating that the device is ready to perform the RTT test.

### EXAMPLE 2

### Forced Delay RTT Test

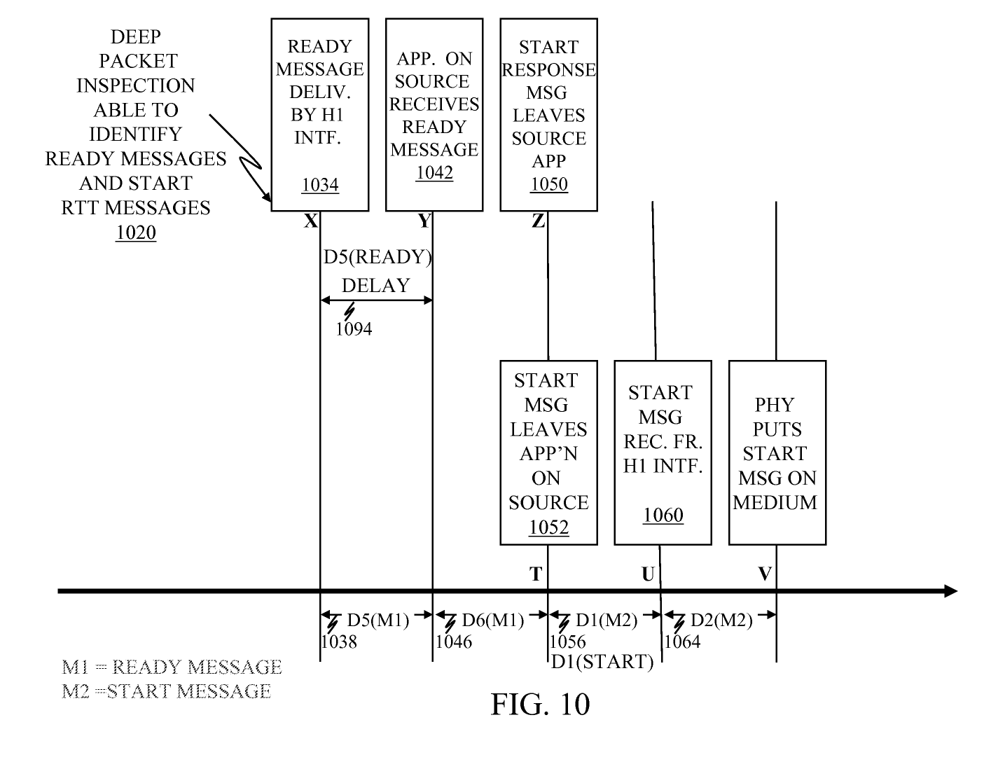

FIG. 10 is an exemplary diagram of other embodiments of the invention, wherein the relationship between a READY message and the START RTT message is separated or broken by controlling when event X(READY) 1034 occurs. A deep packet inspection module is provided typically on the source station, which may be part of the convergence layer or middleware of the source station. The deep packet module 1020 inspects the messages that arrive at the source, particularly to identify the READY message from the sink 1020. The deep packet module or another module may then delay 1094 the READY message until a later time and may then release, or delay transmit, the READY message to the application (event Y 1042) such that the event U(START) 1060, i.e., when the START message is received at the H1 interface, occurs right at or very near or proximate to the start of a CSMA region. When the READY message is released to the application 1042 after the forced delay 1094, the application then generates the response message 1050, 1052, START, which is then transmitted to the H1 interface 1060 (event U).

The deep packet inspection module may also identify the START RTT, particularly when event U(START) 1060 occurs. Thus, the deep packet inspection module is aware of the delay or interval D5(READY) 1038+D6(READY) 1046+D1(START) 1056 and is able to compute the optimal or a good time to deliver future READY messages to the application to ensure that the corresponding future START messages are received at the H1 interface (event U(START)) at the desired time.

The deep packet inspection module is also aware or knows of the structure of the beacon period, i.e., when the one or more CSMA regions begin. This means that the beacon period information may have to be exposed to this module. By knowing the beacon structure and the delay or timing between the READY and START messages, the deep packet module is thus able to determine the appropriate delay 1094. This deep packet module may be provided with sufficient processing power to facilitate deep packet inspection in real time. The exemplary embodiment described in FIG. 10 typically does not impose additional constraints on the HPAV architecture or on the centralized coordinator scheduling function. Furthermore, such embodiments may also work when the H1 interface is a bridging station and the source is on another device outside the network.

### Beacon Period Allocation Modification

The following embodiments described below entail modifying the size of one or more regions, e.g., the CSMA region or the CFP regions. In these exemplary embodiments, the RTT is performed as shown in FIG. 6, without any forced delay, however, with the beacon period allocations modified. These modifications may apply as part of the basic network scheduling allocation architecture. In some embodiments, these modifications may be performed dependent on the measured network load, e.g., as shown in FIG. 3.

### EXAMPLE 1

### Beacon Period Allocation Mod.

In another embodiment of the invention, the beacon period is defined or scheduled such that CFP regions are fragmented and the size of the CFP regions are limited to a maximum duration such that the START RTT message and the STOP RTT message may travel in sequential CSMA regions rather than being forced into the same CSMA region.

### EXAMPLE 2

### Beacon Period Allocation Mod.

In other embodiments of the invention, the network may be prescribed to have a minimum CSMA region size that is of sufficient duration such that it is able to accommodate the relevant delays associated with all the READY, START RTT, and STOP RTT messages, e.g., from D3(READY) to D3(STOP), inclusive. This minimum CSMA region may be of sufficient duration, e.g., from 10 to 15 ms.

### EXAMPLE 3

### Beacon Period Allocation Mod.

In other embodiments of the invention, the minimum CSMA region size that may be allocated remains smaller, but with at least one larger size CSMA region provided periodically, e.g., every 10 to 25 frames. This larger size CSMA is of sufficient duration such that it is able to accommodate the relevant delays associated with all the READY, START RTT, and STOP RTT messages, e.g., from D3(READY) to D3(STOP), inclusive. In this exemplary embodiment, a deep packet entity may be incorporated to identify the READY message and to delay that READY message until the larger size CSMA region begins. This exemplary embodiment in some aspects is similar to Example 2 (RTT with Forced Delay).

### EXAMPLE 4

### Beacon Period Allocation Mod.

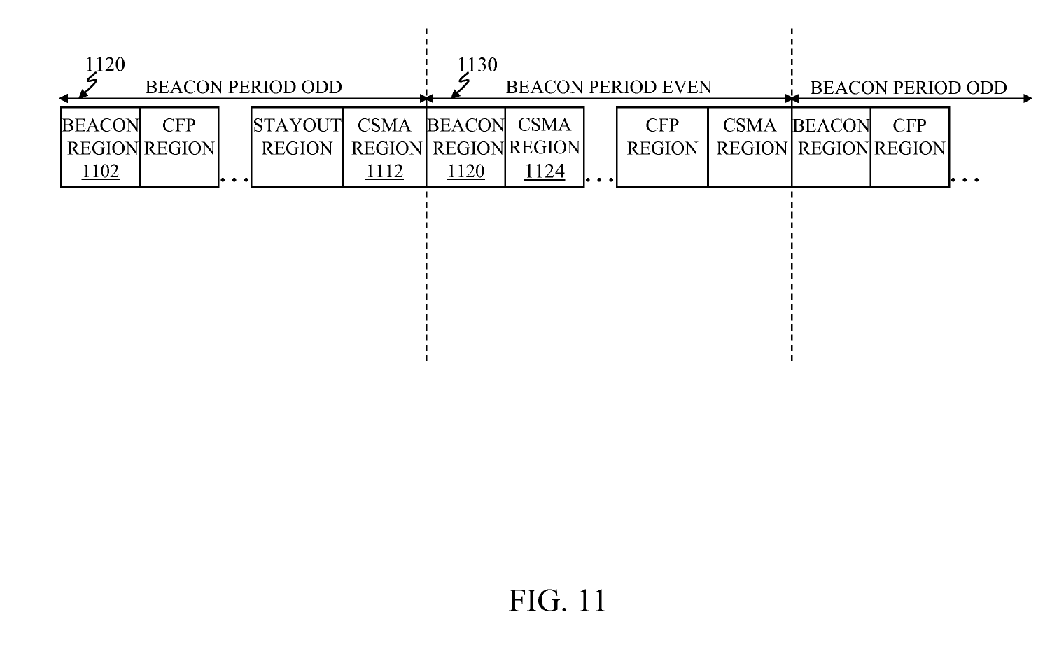

FIG. 11 shows other exemplary embodiments wherein the system provides a sufficiently large CSMA region by “concatenating” smaller consecutive CSMA regions. For example, in odd beacon periods 1120, schedule the CSMA region 1112 at the end of the beacon period; and in even beacon periods 1130, schedule the CSMA region 1124 immediately after the beacon region 1120. The scheduling of these CSMA regions thus provides two consecutive CSMA regions 1112, 1124, separated by a relatively small duration beacon region. This may be handled by defining an architecture or specification adapted to support different CSMA region locations in alternating beacon periods. In some embodiments, each beacon period has a CSMA region immediately following a beacon region and a CSMA region at the end of the beacon period. Other variations of CSMA concatenation may also be provided.

Although the embodiments of the present invention discussed herein are exemplified using DTCP-IP, the features of the present invention may be applied to other platforms, network protocols, transport protocols, applications, and the like. For example, the embodiments of the present invention may also be performed on systems utilizing WMDRM network devices protocol, but typically with a different set of RTT control messages and parameters being exchanged. Similarly, other ping-like commands may be used instead of the echo request and echo reply message utilized in the above exemplary embodiments. Furthermore, the embodiments of the present invention may also apply to various networks, including, but not limited to, 802.11E networks, power line communication networks, Digital Living Network Alliance (DLNA) networks, and non-DLNA networks. The features of the present invention may also apply to other priority-based QOS networks, both wired and wireless, including but not limited to, PLC networks and BLUETOOTH™ networks.

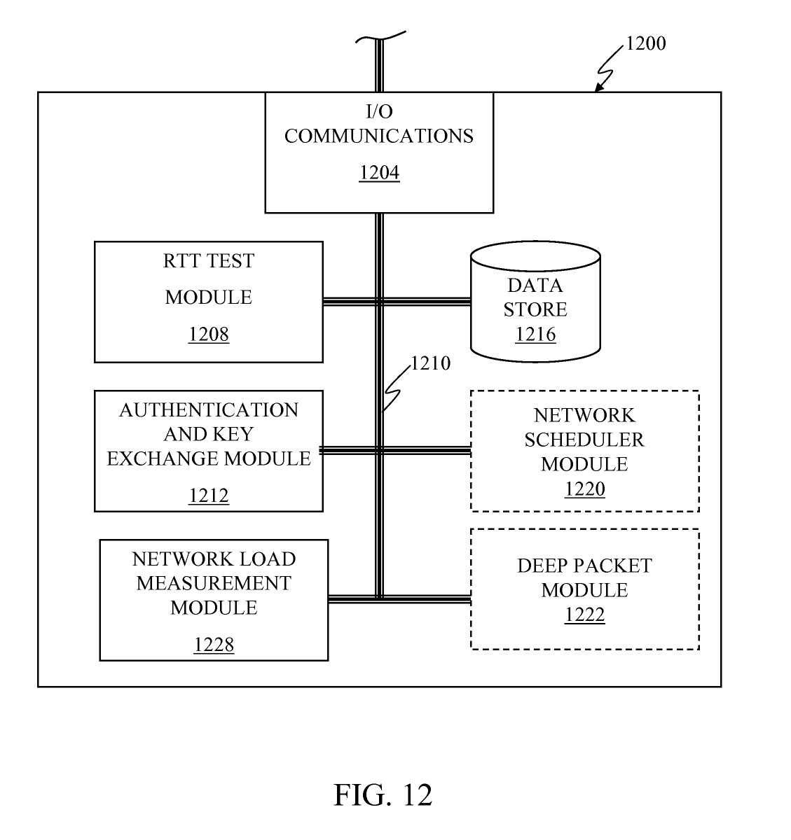

FIG. 12 is a high-level functional block diagram of an exemplary device 1200 according to an embodiment of the invention. Typically, a device 1200 includes an input/output (I/O)-communications module 1204 that enables the device 1200 to communicate with other devices within the network. Furthermore, depending on the functions of the device, the I/O communications module 1204 may also be adapted to communicate and interface with external networks and/or systems, such as the Internet 190 or satellite or terrestrial broadcast 192. This capability to communicate with external networks and/or networks, for example, may be available for set-top boxes that are adapted to receive premium content via cable or through the Internet. The exemplary set-top box 134 thus functions as a source because it transmits content, for example, to a sink or media player, such as an HDTV 130.

A device 1200 may also contain a data store 1216, permanent and/or temporary, such as hard drive, flash memory, smart drive, RAM, etc. A set-top box 134, for example, may include a data store so as to temporarily or permanently store content, for example, sent by content providers. This data store 1216 may also contain other information, such as data-related to the device 1200, such as time, serial number, program instructions, etc. For a DVD player, for example, the data store 1216 may be a removable DVD. The data store may also be used as a temporary volatile storage.

The device 1200 may also include an authentication and key exchange module 1212, adapted to perform authentication and key exchange (AKE)/validation functions. For example, if the device 1200 is DTCP-compliant/certified, the AKE module 1212 authenticates the other endpoint device, e.g., a sink, based on the DTCP authentication framework. In some embodiments, this AKE 1216 module also performs the exchange of encryption keys with the other endpoint device, such that the other endpoint device, e.g., the sink/media player is able to decode and present the protected content sent by the media server. This AKE module 1216 may also be adapted to perform validation functions, such as background processes to determine whether another device is a valid endpoint device to which the device, e.g., functioning as a source, may transmit content.

The device 1200 may also include an RTT test module 1208 adapted to perform proximity detection or RTT tests as described herein. The RTT test module 1208 may be adapted to perform RTT proximity detection with forced delay and/or RTT proximity detection without any forced delay, typically based on the result of a network load measurement test. Information related to the RTT test, such as results, may also be communicated with the AKE module 1212, such that based on the RTT result, the AKE module may then determine 1212, whether an associated content or an encryption key is to be sent.

The network load measurement module 1228 is adapted to perform the network load measurement function described herein. This module is adapted to send an echo reply or echo request, depending if this device 1200 is the initiator of the network load measurement feature of the present invention. Based on the measured network load, this module 1228 may interface with the RTT module 1208 such that the RTT module performs the appropriate RTT test, i.e., with forced delay or without.

If the device performs the exemplary embodiment described in FIG. 10 and its associated text or the exemplary beacon allocation modification (EXAMPLE 3 above), the device 1200 may also include a deep packet module 1222 that is adapted to read messages that are received by the device 1200 and determine if the appropriate READY or START RTT messages are received and when they are received. The deep packet module 1200 may interface with the RTT module such that the appropriate message is delayed prior to transmission according to the exemplary embodiments described herein. The deep packet module 1222 may also calculate the appropriate delay. The deep packet module 1222 may interface with the RTT test module 1208 to ensure that the appropriate delays are provided during the appropriate RTT tests.

If the device also functions as a central coordinator that schedules and allocates network activities, the device 1200 may also include a network scheduler 1222 adapted to define and schedule the appropriate regions, e.g., CSMA or CFP, within the beacon periods. The network scheduler 1220 may also broadcast the beacon periods via a beacon during one or more of the appropriate beacon regions.

If a device 1200 is also functioning as a source, it may be embodied in many forms as discussed above, including, for example, as a set-top box 134, a computer 142, and a DVD player 160. In some embodiments, a device is adapted to function either as a source/TX 202 or an RX/sink 206, i.e., the device has both capabilities. Depending on its current role, the device may function as a source or a receiver. If the device is a sink, the device 1200 may be embodied for example in a computer, HDTV, monitor, etc.

In some embodiments of the invention, the different modules 1204, 1208, 1212, 1216, 1220, 1222, 1228 may communicate and interface with each other via a bus, dedicated signal paths or one or more channels 1210. Depending on the function of the device, other modules, including functions and capabilities, may be added or removed. For example, a set-top box may have a user interface module adapted to present information to the users, such as presenting available premium content for consumers to view and/or purchase. Furthermore, the modules described herein may be combined, e.g., the RTT test module 1208 and the AKE module 1212 may be combined into a module adapted to perform some or all functions of the various modules. Furthermore, the modules described herein may be further subdivided and combined with other functions so long as the function and processes described herein may be performed. The various modules may also be implemented in hardware, software, or both, i.e., firmware.

Embodiments of the present invention may be used in conjunction with networks, systems, and devices that may employ proximity detection sensors and testing schemes between one or more devices, particularly those that support non-contention based access. Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

We claim:

1. A method of proximity detection within a network, the method comprising the steps of:
determining a network load;
if the determined network load meets a defined condition, then performing a round trip time (RTT) proximity detection test; and
if the determined network load fails the defined condition, then performing a forced delay RTT proximity detection test with a forced delay.

2. The method of claim 1, wherein the step of determining the network load further comprises:
sending a request message requesting an echo reply message;
receiving the echo reply message;
determining a time difference between the step of sending the request message and the step of receiving the echo reply message to determine the network load.

3. The method of claim 2, wherein the request message comprises a timestamp of when the request message is sent.

4. The method of claim 3, wherein the echo reply message comprises the timestamp of when the request message is sent.

5. The method of claim 1, wherein the step of performing the RTT proximity detection test further comprises:
sending a first message indicating to a receiving device to prepare for initiation of the RTT proximity detection test;
receiving a second message in response to the first message indicating that the receiving device is ready for the RTT proximity detection test;
sending a START message adapted to trigger initiation of the RTT proximity detection test;
receiving a STOP message adapted to trigger completion of the RTT proximity detection test; and
determining a round trip time based on the step of sending the START message and the step of receiving the STOP message.

6. The method of claim 1, further comprising the step of:
if the determined network load fails the defined condition, scheduling a network allocation, wherein at least one contention-based access period is of a duration adapted to accommodate a delay incurred to transmit a START message and receive a STOP message.

7. The method of claim 1, further comprising the steps of:
if the determined network load fails the defined condition:
sending a SETUP message indicating to a receiving device to prepare for initiation of the forced delay RTT proximity detection test;
receiving a READY message in response to the SETUP message indicating that the receiving device is ready for the forced delay RTT proximity detection test;
sending, after the forced delay, the START message adapted to trigger initiation of the forced delay RTT proximity detection test;
receiving a STOP message adapted to trigger completion of the forced delay RTT proximity detection test; and
determining a round trip time based on the step of sending the START message and the step of receiving the STOP message.

8. The method of claim 6, wherein the delay incurred to transmit the START message and receive the STOP message comprises D3(START)+D4(START)+D5(START)+D6(START)+D1(STOP)+D2(STOP)+D3(STOP).

9. The method of claim 7, wherein the forced delay occurs between when an application receives the READY message and when the START message leaves the application.

10. The method of claim 7, wherein the forced delay value is greater or equal than (≧) 1 time unit of a beacon period and less than (<) a beacon period duration.

11. The method of claim 7, wherein the forced delay value is greater than one beacon period duration.

12. The method of claim 1, wherein the step of performing the forced delay RTT proximity detection test further comprises:
identifying READY messages and START messages;
determining the timing between the READY messages and the START messages;
sending a SETUP message indicating to a receiving device to prepare for initiation of the forced delay RTT proximity detection test;
receiving at a first interface a READY message, prior to receiving the READY message by an application associated with a source device, in response to the SETUP message;
transmitting, after the forced delay, the READY message received at the first interface, wherein the forced delay is based on the determined timing, and wherein the forced delay is timed to schedule the reception of a START message proximate to a contention-based access period;
sending the START message in response to the transmitted READY message near the beginning of the contention-based access period, the START message adapted to trigger initiation of the forced delay RTT proximity detection test;
receiving the STOP message adapted to trigger completion of the forced delay RTT proximity detection test; and
determining a round trip time based the step of sending the START message and the step of receiving the STOP message.

13. The method of claim 12, wherein the forced delay comprises D5(READY)+D6(READY)+D1(START).

14. The method of claim 12, wherein the contention-based access period is adapted to accommodate D3(START)+D4(START)+D5(START)+D6(START)+D1(STOP)+D2(STOP)+D3(STOP).

15. The method of claim 1, wherein at least one of the following: RTT proximity detection test and forced delay RTT proximity detection test, conforms to at least one of the following: DTCP-IP and WMDRM-ND.

16. The method of claim 1 wherein the network provides Quality of Service by allocating one or more contention-free periods.

17. A method of proximity detection, the method comprising the steps of:
receiving, by a first device, a message from a second device indicating that the second device is ready to perform a forced delay round trip time (RTT) proximity detection test; and
transmitting after a forced delay, by the first device, a response message in response to the received message, the response message adapted to trigger initiation of the forced delay RTT test.

18. The method of claim 17, wherein the first device is a source device and the second device is a receiver device.

19. The method of claim 17, wherein the forced delay of the step of transmitting the response message is a time greater or equal than (≧) 1 time unit of a beacon period and less than (<) a beacon period.

20. The method of claim 17, wherein the forced delay value is greater than one beacon period duration.

21. The method of claim 17, further comprising the step of:
transmitting, by the second device, a message adapted to trigger completion of the forced delay RTT test in response to receiving the response message from the first device.

22. The method of claim 21, further comprising the steps of:
allocating at least one contention-free period within at least one beacon period; and
allocating at least one contention-based access period within the at least one beacon period, wherein the at least one contention-based access period is of a duration adapted to accommodate a delay associated with the first device transmitting the response message and a delay associated with the second device transmitting a message adapted to trigger completion of the forced delay RTT test.

23. A method of proximity detection, the method comprising the steps of:
identifying ready messages, each of the ready messages indicating that a device is ready for a round trip time (RTT) proximity detection test;
releasing to an application, after a forced delay, at least one ready message of the ready messages;
transmitting a start message adapted to trigger initiation of the RTT proximity test, in response to the at least one ready message; and
receiving the start message at an interface operably connected to a source device, wherein the forced delay is based on having the step of receiving the start message occur proximate to a contention-based access period.

24. The method of claim 23, wherein the step of identifying the ready messages is performed when the ready messages are received at the interface.

25. The method of claim 23 wherein the step of identifying the ready messages is performed by a source device.

26. The method of claim 23 further comprising the step of:
transmitting a stop message adapted to trigger completion of the RTT proximity, in response to receiving the start message.

27. The method of claim 26 wherein the step of transmitting the stop message is performed by a receiver device.

28. The method of claim 23 further comprising the step of:
identifying start messages received at the interface; and
determining an interval between when a ready message of the identified ready messages is received at the interface and when a start message of the identified start messages is received at the interface; and
wherein the forced delay is based on the determined interval.

29. A device adapted to be operably coupled with another device via at least one network segment, the device comprising:
a network load measurement module adapted to:
send a request message requesting an echo reply message;
receive the echo reply message; and
determine the time difference between the sending of the request message and the reception of the echo reply message to determine a network load; and
a round trip time (RTT) test module adapted to:
perform a RTT proximity detection test; and
perform a forced delay RTT proximity detection test when the determined network load does not satisfy a defined condition.

30. The device of claim 29 further comprising:
a network scheduler module adapted to:
allocate regions within a beacon period indicating network scheduling and allocation information.

31. The device of claim 29 wherein the RTT test module is further adapted to:
send a SETUP message indicating to a receiving device to prepare for initiation of the RTT proximity detection test;
receive a READY message in response to the SETUP message indicating that the receiving device is ready for the RTT proximity detection test;
send a START message adapted to trigger initiation of the RTT proximity detection test;
receive a STOP message adapted to trigger completion of the RTT proximity detection test; and
determine a round trip time based on the sending of the START message and the receiving of the STOP message.

32. The device of claim 29 wherein the network scheduler module is further adapted to:
schedule a network allocation, wherein at least one contention-based access period is of a duration adapted to accommodate a delay incurred to transmit a START message and receive a STOP message;

33. The device of claim 29 wherein the RTT test module is further adapted to:
send a SETUP message indicating to a receiving device to prepare for initiation of the forced delay RTT proximity detection test;
receive a READY message in response to the SETUP message indicating that the receiving device is ready for the forced delay RTT proximity detection test;
send, after the forced delay, the START message adapted to trigger initiation of the forced delay RTT proximity detection test;
receive the STOP message adapted to trigger completion of the forced delay RTT proximity detection test; and
determine a round trip time based on the sending of the START message and the receiving of the STOP message.

34. The device of claim 29 further comprising:
a deep packet module adapted to:
identify READY messages and START messages; and
determine the timing between the READY messages and the START messages.

35. The device of claim 29 wherein the RTT test module is further adapted to:
send a SETUP message indicating to a receiving device to prepare for initiation of the forced delay RTT proximity detection test;
receive at a first interface a READY message in response to the SETUP message;
transmit, after the forced delay, the READY message received at the first interface, prior to receiving the READY message by an application associated with a source device, wherein the forced delay is based on the determined timing of a deep packet module adapted to identify READY messages and START messages and determine the timing between the READY messages and the START messages, and wherein the forced delay is timed to schedule the reception of a START message proximate to a contention-based access period;
send the START message adapted to trigger initiation of the forced delay RTT proximity detection test in response to the transmitted READY message at the at least one contention-based access period;
receive the STOP message adapted to trigger completion of the forced delay RTT proximity detection test; and
determine a round trip time based on the sending of the START message and the receiving of the STOP message.

36. A system comprising:
a first device operably coupled to a second device via at least one network segment, the first device adapted to:
send a SETUP message indicating to a second device to prepare for initiation of a forced delay RTT proximity detection test;
receive a READY message in response to the SETUP message indicating that the second device is ready for the forced delay RTT proximity detection test;
after a forced delay, send the START message adapted to trigger initiation of the forced delay RTT proximity detection test;
receive the STOP message adapted to trigger completion of the forced delay RTT proximity detection test; and
determine a round trip time based on the sending of the START message after a forced delay and the receiving of the STOP message;
the second device adapted to:
receive the SETUP message;
send a READY message in response to the received SETUP message when the second device is ready for the forced delay RTT proximity detection test;
receive the START message;
send the STOP message; and
the at least one network segment.

37. The system of claim 36, wherein the force delay is selected from at least one of the following:
greater or equal than (÷) 1 time unit of a beacon period and less than (<) a beacon period duration; and
greater than one beacon period duration.

38. The system of claim 36 further comprising:
a network load measurement module adapted to:
send a request message requesting an echo reply message;
receive the echo reply message;
determine a time difference between the sending of the request message and the receiving of the echo reply message to determine a network load;
wherein the network load measurement module is operably coupled to at least one of the following: the first device and the second device.

39. The system of claim 38 wherein the network load measurement module is resident in at least one of the following: the first device and the second device.

40. The system of claim 36 further comprising:
a central coordinator operably coupled to the first device and the second device, the central coordinator adapted to:
allocate at least one contention-free period within at least one beacon period; and
allocate at least one contention-based access period within the at least one beacon period, wherein the at least one contention-based access period is of a duration adapted to accommodate a delay associated with the first device sending the START message and a delay associated with the second device sending the STOP message.

41. The system of claim 36 further comprising:
a deep packet module operably coupled to the first device, the deep packet module adapted to:
identify READY messages and START messages within the system; and
determine the timing between the READY messages and the START messages.
